(19) United States
(12) Patent Application Publication
(10) Pub. No.: US 2019/0100686 A1
(43) Pub. Date: Apr. 4, 2019

(54) PARAFFIN INHIBITION BY CALIXARENES

(71) Applicant: SI GROUP, INC., Schenectady, NY (US)

(72) Inventor: Robert CABLE, Schenectady, NY (US)

(21) Appl. No.: 15/879,321

(22) Filed: Jan. 24, 2018

Related U.S. Application Data
(60) Provisional application No. 62/567,639, filed on Oct. 3, 2017.

(51) Int. Cl. C09K 8/524; C10G 75/04; F17D 3/12

(52) U.S. Cl. CPC C09K 8/524; F17D 3/12; C10G 75/04

(57) ABSTRACT

This invention relates to a paraffin-containing fluid composition comprising a phenolic resin containing one or more calixarene compounds (i.e., a calixarene resin). The invention also relates to methods for dispersing paraffin crystals, inhibiting paraffin crystal deposition, or treating a well or vessel to reduce the deposition of paraffin crystals, with a calixarene resin.

This application claims priority to U.S. Provisional Application No. 62/567,639, filed on Oct. 3, 2017, which is herein incorporated by reference in its entirety.

### FIELD OF THE INVENTION

The invention generally relates to a paraffin-containing fluid composition. For example, the invention relates to methods for dispersing paraffin crystals, inhibiting paraffin crystal deposition, or treating a well or vessel to reduce the deposition of paraffin crystals.

### BACKGROUND

Paraffin deposition is typically of a concern in wells, flowlines, or pipelines carrying paraffin-containing petroleum fluids. Paraffin deposition occurs when pipe and vessel surface temperatures fall below both the bulk paraffin-containing petroleum fluid temperature and the temperature at which paraffins will start to crystallize from the petroleum fluid. Paraffin deposition is particularly problematic in arctic and deepwater subsea flowlines and pipelines due to the cold temperatures of these environments. Gelling of paraffin-containing petroleum fluids can occur due to the formation of a crystalline paraffin lattice network within the fluids. This gelling can result in an increase in the viscosity of the fluid up to the point where the fluids will no longer flow. All these conditions can be undesirable, causing reduced operating efficiencies, shut-ins, and cleaning operation costs.

Despite the growth in the use of oilfield paraffin-control chemicals, technical challenges still exist with respect to the design and application of these chemicals.

Therefore, there is a need in the petroleum fluid production industry to develop new chemistries to address paraffin deposition control and pour point depression, and the technology gaps existing in currently available commercial paraffin inhibitors. This invention answers those needs.

### SUMMARY OF THE INVENTION

One aspect of the invention relates to a paraffin-containing fluid composition comprising: a) a paraffin-containing fluid; and b) a resin comprising one or more calixarene compounds, wherein the resin is at least partially soluble in the paraffin-containing fluid. The resin disperses the paraffin in the fluid composition and/or inhibits the deposition of the paraffin crystals.

In one embodiment, the resin is a phenolic aldehyde calixarene resin prepared in the presence of a base catalyst.

In some embodiments, the phenolic units in the resin are the same or different phenolic compounds, each compound independently selected from the group consisting of phenol, resorcinol, and pyrogallol, wherein the benzene rings of the phenolic units are independently substituted with H, C₁ to C₃₀ alkyl, phenyl, or arylalkyl. In one embodiment, the phenolic units in the resin are the same or different phenols, each independently substituted with H or C₁ to C₂₀ alkyl. For instance, the phenolic units in the resin are the same or different phenols, each independently substituted with C₄ to C₁₂ alkyl.

In one embodiment, the total number of units in the calixarene compounds is from 4-8.

In one embodiment, the paraffin-containing fluid is a hydrocarbon fluid selected from the group consisting of a crude oil, home heating oil, lubricating oil, and natural gas.

In some embodiments, the paraffin-containing fluid contains at least 0.05 wt % of paraffin or paraffin wax. In one embodiment, the paraffin-containing fluid contains about 0.5 to about 15 wt % of paraffin or paraffin wax.

In some embodiments, the amount of the resin is from about 1 to about 10,000 parts per million in the paraffin-containing fluid. In one embodiment, the amount of the resin is from about 10 to about 100 parts per million in the paraffin-containing fluid.

Another aspect of the invention relates to a method for dispersing paraffin crystals or inhibiting paraffin crystal deposition in a paraffin-containing fluid. The method comprises adding to a paraffin-containing fluid, an effective amount of a resin comprising one or more calixarene compounds, wherein the resin is at least partially soluble in the paraffin-containing fluid. The resin disperses the paraffin in the paraffin-containing fluid and/or inhibits the deposition of the paraffin crystals.

In one embodiment, the resin is a phenolic aldehyde calixarene resin prepared in the presence of a base catalyst.

In some embodiments, the phenolic units in the resin are the same or different phenolic compounds, each compound independently selected from the group consisting of phenol, resorcinol, and pyrogallol, wherein the benzene rings of the phenolic units are independently substituted with H, C₁ to C₃₀ alkyl, phenyl, or arylalkyl. In one embodiment, the phenolic units in the resin are the same or different phenols, each independently substituted with H or C₁ to C₂₀ alkyl. For instance, the phenolic units in the resin are the same or different phenols, each independently substituted with C₄ to C₁₂ alkyl.

In one embodiment, the total number of units in the calixarene compounds is from 4-8.

In one embodiment, the well or vessel surface is the surface of a gas well, oil well, pipeline, flowline, tank, tank car, or processing vessel.

In some embodiments, the resin composition further comprises a fluid that the resin is at least partially soluble in. For instance, the fluid is a hydrocarbon fluid selected from the group consisting of a crude oil, home heating oil, lubricating oil, and natural gas. In one embodiment, the fluid is a paraffin-containing fluid. The paraffin-containing fluid may contain at least 0.05 wt % of paraffin or paraffin wax. For instance, the paraffin-containing fluid contains about 0.5 to about 15 wt % of paraffin or paraffin wax. In one embodiment, the fluid comprises one or more hydrocarbon solvents. For instance, the hydrocarbon solvents are selected from the group consisting of kerosene, diesel, heptane, benzene, toluene, xylene, C₉-C₁₂ aromatic hydrocarbon solvents, and combinations thereof. In one embodiment, the amount of the resin is from about 1 to about 10,000 parts per million in the fluid. For instance, the amount of the resin is from about 10 to about 100 parts per million in the fluid.

Another aspect of the invention relates to a method for treating a well or vessel surface to reduce the deposition of paraffin crystals on the well or vessel surface. The method comprises treating the well or vessel surface with a resin composition comprising an effective amount of a resin. The resin comprises one or more calixarene compounds. The treatment reduces the deposition of paraffin crystals on the well or vessel surface.

In one embodiment, the resin is a phenolic aldehyde calixarene resin prepared in the presence of a base catalyst.

In one embodiment, the phenolic units in the resin are the same or different phenolic compounds, each independently selected from the group consisting of phenol, resorcinol, and pyrogallol, wherein the benzene rings of the phenolic units are independently substituted with H, C₁ to C₃₀ alkyl, phenyl, or arylalkyl.

In some embodiments, the phenolic units in the resin are the same or different phenols, each independently substituted with H or C₁ to C₂₀ alkyl. In one embodiment, the phenolic units in the resin are the same or different phenols, each independently substituted with C₄ to C₁₂ alkyl.

In one embodiment, the total number of units in the calixarene compounds is from 4-8.

In one embodiment, the paraffin-containing fluid is a hydrocarbon fluid selected from the group consisting of a crude oil, home heating oil, lubricating oil, and natural gas.

In some embodiments, the paraffin-containing fluid contains at least 0.05 wt % of paraffin or paraffin wax. In one embodiment, the paraffin-containing fluid contains about 0.5 to about 15 wt % of paraffin or paraffin wax.

In some embodiments, the amount of the resin is from about 1 to about 10,000 parts per million in the paraffin-containing fluid. In one embodiment, the amount of the resin is from about 10 to about 100 parts per million in the paraffin-containing fluid. The resin improves the paraffin dispersion and/or inhibits the paraffin deposition by at least 20% compared to a paraffin-containing fluid composition that does not contain the resin. For instance, the resin improves the paraffin dispersion and/or inhibits the paraffin deposition by at least 40% compared to a paraffin-containing fluid composition that does not contain the resin.

### BRIEF DESCRIPTION OF THE DRAWINGS

FIG. 1 shows the paraffin inhibition performance (% inhibition) of an exemplary calixarene resin in a simulated waxy crude at different dosage levels (1000 ppm, 500 ppm, 250 ppm, and 100 ppm, respectively). The calixarene resin and the simulated waxy crude are described in Example 2.

### DETAILED DESCRIPTION OF THE INVENTION

This invention relates to utilization of a resin comprising one or more calixarene compounds (which is herein sometimes referred to as a “calixarene resin”) to disperse paraffin crystals and/or inhibit paraffin crystal deposition in a paraffin-containing fluid. The paraffin inhibiting performance of the calixarene resins was evaluated on simulated crude oils as well as various oilfield crude oils, which showed that the calixarene resins exhibited paraffin inhibiting abilities. The calixarene resin can thus be useful in the oilfield industry to reduce the paraffin deposition on well or vessel surfaces, as well as in industrial and home/personal care product markets to disperse paraffin crystals in a fluid matrix.

One aspect of the invention relates to a paraffin-containing fluid composition comprising: a) a paraffin-containing fluid; and b) a resin comprising one or more calixarene compounds, wherein the resin is at least partially soluble in the paraffin-containing fluid. The resin disperses the paraffin in the fluid composition or inhibits the deposition of the paraffin crystals. The resins to be used in a paraffin-containing fluid composition are phenolic aldehyde resins including a mixture of linear phenolic resins and cyclic phenolic resins, such as phenolic aldehyde calixarenes, and are herein sometimes referred to as “calixarene resins.”

The calixarene resin may be a phenolic aldehyde resin prepared by the condensation reaction between one or more phenolic compounds and one or more aldehydes.

The phenolic compound may be a monohydric, dihydric, or polyhydric phenol, with and without substituents on the benzene ring of the phenolic compound. Suitable monohydric, dihydric, or polyhydric phenols include, but are not limited to, phenol; dihydricphenols such as resorcinol, catechol, and hydroquinone; trihydricphenols such as pyrogallol, hydroxy quinol, or phloroglucinol; dihydroxybiphenol; alkylidenebisphenols such as 4,4′-methylenediphenol (bisphenol F), and 4,4′-isopropylidenediphenol (bisphenol A); trihydroxybiphenol; and thiobisphenols. Exemplary monohydric, dihydric, or polyhydric phenols include phenol, resorcinol, and pyrogallol. In one embodiment, the phenolic compound is phenol.

The benzene ring of the monohydric, dihydric, or polyhydric phenols can be substituted in the ortho, meta, and/or para positions by one or more linear, branched, or cyclic C₁-C₃₀ alkyl, or halogen (F, Cl, or Br). For example, the benzene ring of the monohydric, dihydric, or polyhydric phenol can be substituted by C₁-C₁₆ alkyl, C₁-C₆ alkyl, or C₁-C₄ alkyl. Suitable substituents on the benzene ring also include C₁-C₃₀ aralkyl, C₁-C₃₀ alkanoyl, and C₁-C₃₀ aroyl. Exemplary substituents on the benzene ring of the monohydric, dihydric, or polyhydric phenols include C₁-C₃₀ alkyl, phenyl, or arylalkyl.

In certain embodiments, the phenolic units in the calixarene resin are phenol, resorcinol, or pyrogallol, wherein the benzene rings of the phenols are independently substituted with H or C₁-C₂₀ alkyl (e.g., C₄ to C₁₂ alkyl). In certain embodiments, the benzene rings of the phenols are substituted with one substituent of C₁-C₂₀ alkyl (e.g., C₄ to C₁₂ alkyl).

In one embodiment, the phenolic compound is phenol, with the benzene ring being substituted with one substituent of C₁-C₂₀ alkyl (e.g., C₄ to C₁₂ alkyl).

Any aldehyde known in the art for preparing a phenolic aldehyde resin is suitable in the condensation reaction. Exemplary aldehydes include formaldehyde, methylformcel, butylformcel, acetaldehyde, propionaldehyde, butyraldehyde, crotonaldehyde, valeraldehyde, caproaldehyde, heptaldehyde, benzaldehyde, as well as compounds that decompose to aldehyde such as paraformaldehyde, trioxane, furfural, hexamethylenetriamine, aldol, β-hydroxybutyraldehyde, and acetals, and mixtures thereof. A typical aldehyde used is formaldehyde.

The calixarene resins may include a mixture of linear phenolic resins and cyclic phenolic resins. The linear phenolic resins may be a linear phenol-aldehyde resin, linear resorcinol-aldehyde resin, or linear pyrogallol-aldehyde resin, with or without substituents on the benzene rings of the phenolic compounds. When the linear phenolic resins contain substituents on the benzene rings, the substituents are typically at either the ortho or para position to the hydroxyl of linear phenolic resins.

A typical linear phenol-aldehyde resin has a structure of Formula (A):

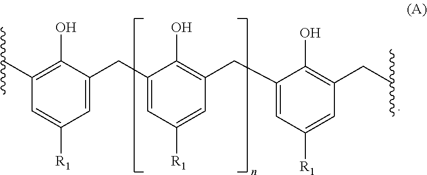

A typical linear resorcinol-aldehyde resin has a structure of Formula (B-1) or (B-2):

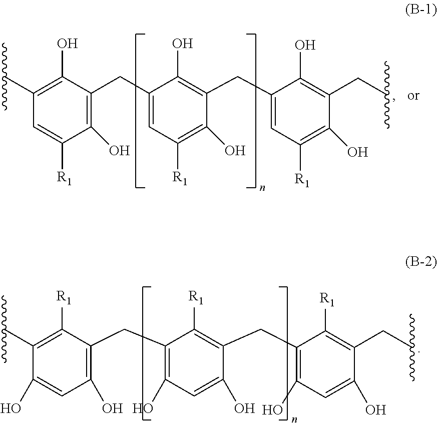

A typical linear pyrogallol-aldehyde resin has a structure of Formula (C):

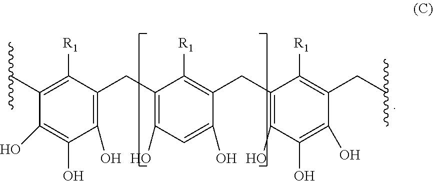

Typically, the substituent group on the benzene ring of the linear phenolic resin (e.g., R₁ in Formulas (A), (B-1), (B-2), and (C)) may be independently H, C₁ to C₃₀ alkyl, phenyl, or arylalkyl. For instance, the substituent group (e.g., R₁ in Formulas (A), (B-1), (B-2), and (C)) may be independently C₄ to C₁₈ alkyl, C₄ to C₁₂ alkyl, or C₁ to C₇ alkyl. In one embodiment, at least one substituent group (R₁ in Formulas (A), (B-1), (B-2), and (C)) on the benzene ring of the linear phenolic resin is C₁ to C₅ alkyl, such as C₄ or C₅ alkyl. The number of repeating units of the linear phenolic resin (e.g., n in Formulas (A), (B-1), (B-2), and (C)) may be 2 to 100, for instance, 2 to 50, 2 to 30, 2 to 20, 2 to 10, 2 to 8, 2 to 6, or 2 to 4, resulting in a molecular weight typically ranging from about 500 to about 25,000 daltons, from about 500 to about 10,000 daltons, from about 500 to about 5,000 daltons, from about 1,000 to about 5,000 daltons, from about 500 to about 3,000 daltons, or from about 500 to about 1,000 daltons.

The phenolic resins contain calixarenes ranging from about 5% to about 100%, for instance, from about 40% to about 90%, from about 50% to about 90%, from about 50% to about 80%, or from about 55% to about 75%.

The term “calixarene” generally refers to a variety of derivatives that may have one or more substituent groups on the hydrocarbons of cyclo{oligo[(1,3-phenylene)methylene]}. The term “calixarene” also generally encompasses the cyclic structure formed by not only a monohydric phenol, such as phenol, but also dihydric or polyhydric phenol. The calixarenes may contain a substituent on the benzene ring of calixarenes. Exemplary cyclic structures of the calixarenes are those formed by phenol, resorcinol, or pyrogallol.

A typical calixarene compound based on phenols has a structure of Formula (A′):

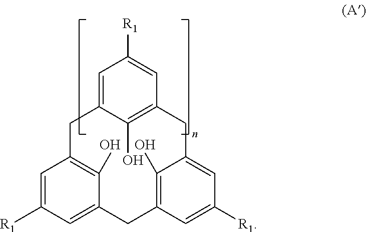

A typical calixarene compound based on resorcinols has a structure of Formula (B-1′) or (B-2′):

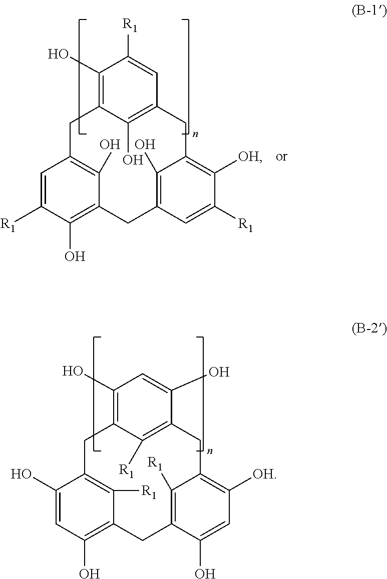

A typical calixarene compound based on pyrogallols has a structure of Formula (C′):

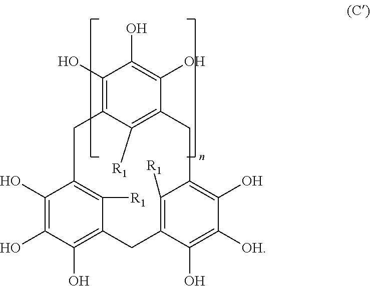

Typically, the substituent group on the benzene ring of the calixarene (e.g., R₁ in Formulas (A′), (B-1′), (B-2′), and (C′)) may be independently H, C₁ to C₃₀ alkyl, phenyl, or arylalkyl. For instance, the substituent group (e.g., R₁ in Formulas (A′), (B-1′), (B-2′), and (C′)) may be independently C₄ to C₁₈ alkyl, C₄ to C₁₂ alkyl, or C₁ to C₇ alkyl. In one embodiment, at least one substituent group (R₁ in Formulas (A′), (B-1′), (B-2′), and (C′)) on the benzene ring of the calixarene is C₁ to C₅ alkyl, such as C₄ or C₅ alkyl. The number of repeating units of the calixarene (e.g., n in Formulas (A′), (B-1′), (B-2′), and (C′)) may be 2 to 100, for instance, 2 to 50, 2 to 30, 2 to 20, 2 to 10, 2 to 8, 2 to 6, or 2 to 4, resulting in a molecular weight typically ranging from about 500 to about 25,000 daltons, from about 500 to about 10,000 daltons, from about 500 to about 5,000 daltons, from about 1,000 to about 5,000 daltons, from about 500 to about 3,000 daltons, or from about 500 to about 1,000 daltons.

In certain embodiments, the calixarene compounds in the resin comprise 4-100 units of formula (II):

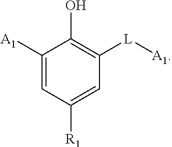

Each R₁ is independently a H, C₁ to C₃₀ alkyl, phenyl, or arylalkyl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each n is independently an integer from 1 to 2; each A₁ represents a direct covalent bond to an adjacent unit of formula (II) such that there is one L group between adjacent units, whereby the total units in the calixarene compound form a ring.

In one embodiment, each R₁ is independently a C₄ to C₁₂ or C₂₄ to C₂₈ alkyl; and wherein the total number of units in the calixarene compounds is from 4-8. In one embodiment, at least one R₁ group is C₁ to C₅ alkyl, such as C₄ or C₅ alkyl.

In one embodiment, L may be —CH₂— or —CH₂—O—CH₂—.

The phenolic aldehyde resins, e.g., phenolic novolac resins, can be prepared in any suitable manner known in the art for preparation of phenolic resins. Typically, one or more phenolic compounds are reacted with an aldehyde to form a phenolic resin. An additional aldehyde may be added later to adjust the desirable melt point of the phenolic resin. Examples of such processes can be found in U.S. Pat. No. 7,425,602 to Howard et al., which is hereby incorporated by reference in its entirety, to the extent not inconsistent with the subject matter of this disclosure.

The reaction of the phenolic compound and the aldehyde is conducted in the presence of a base catalyst. Such base-catalyzed reaction results in phenolic resins containing a mixture of linear phenolic resins and calixarenes.

Alternatively, the reaction of the phenolic compound and the aldehyde can also be carried out under high-dilution conditions. For instance, the reaction of the phenolic compound and the aldehyde may be conducted in the presence of a large amount of a solvent, e.g., with the solvent concentration of about 80 wt %.

Suitable phenolic compounds for preparing the phenolic resins are those described herein. In the case of a monohydric phenol with a substituent group being used to form the phenolic resin, if the substituent group is at the para position to the hydroxyl group of the phenolic compound, the resulting alkylene bridge (e.g., methylene bridge if formaldehyde is used) extends in the ortho positions to the hydroxyl group of the phenolic compound; if the substituent group is at the ortho position to the hydroxyl group of the phenolic compound, the resulting alkylene bridge can extend in the para position to the hydroxyl group of the phenolic compound and the other substituted ortho position to the hydroxyl group of the phenolic compound. In the case of a dihydric phenol being used to form the phenolic resin, the location of the alkylene bridge (e.g., methylene bridge if formaldehyde is used) can also vary depending on the relative position of the hydroxyl groups and the substituent groups. For instance, two possible connections of the phenolic units are shown in Formula (B-1′) and (B-2′) above. In the case of a trihydric phenol being used to form the phenolic resin, the location of the alkylene bridge (e.g., methylene bridge if formaldehyde is used) can also vary depending on the relative positions of the hydroxyl groups and the substituent group. For instance, a possible connection of the phenolic units is shown in Formula (C′) above.

The substituent on the benzene ring of the phenolic compound may be C₁-C₃₀ alkyl, phenyl, or arylalkyl. Typically, the phenolic compound contains one C₁ to C₁₈ alkyl substituent at the para position. Exemplary phenolic compounds are phenol and alkylphenols including para-methylphenol, para-tert-butylphenol (PTBP), para-sec-butylphenol, para-tert-hexylphenol, para-cyclohexylphenol, para-tert-octylphenol (PTOP), para-isooctylphenol, para-decylphenol, para-dodecylphenol, para-tetradecyl phenol, para-octadecylphenol, para-nonylphenol, para-pentadecylphenol, and para-cetylphenol.

The phenolic resins may be prepared from one or more phenolic compounds reacting with one or more aldehydes forming an oligomer of repeating units of phenolic monomers. The resulting linear phenolic resin may be a homopolymer of the same phenolic monomer, or a copolymer containing different units of phenolic monomers, e.g., when two or more different phenolic compounds were reacted with an aldehyde. Similarly, the resulting calixarenes may be a homopolymer of the same phenolic monomer or a copolymer containing different units of phenolic monomers.

In certain embodiments, the phenolic units in the calixarene resin can be the same or different phenolic compounds. Each phenolic compound can be independently phenol, resorcinol, or pyrogallol. The benzene rings of each phenolic compound can be independently substituted with H, C₁ to C₃₀ alkyl, phenyl, or arylalkyl. For instance, the phenolic units in the calixarene resin are the same or different phenols, and the benzene ring of each phenol is independently substituted with H or C₁ to C₂₀ alkyl (e.g., C₄ to C₁₂ alkyl).

Suitable aldehydes for preparing the phenolic resins are those described herein. In one embodiment, the aldehyde used is formaldehyde.

To prepare a phenolic resin, the molar ratio of the total amount of an aldehyde to phenolic compounds is in the range from 0.5:1 to 1:1, for instance, from 0.8:1 to 1:1, or from 0.9:1 to 1:1.

The weight average molecular weight of the resin used herein may range from about 500 to about 25,000 daltons, from about 1000 to about 10,000 daltons, from about 1000 to about 8,000 daltons, from about 1000 to about 5,000 daltons, or from about 2000 to about 5000 daltons. Increasing the molecular weight of the resin may increase the paraffin inhibition performance of the resin.

Additionally, as discussed above, the calixarene resins may include a mixture of linear phenolic resins (containing linear phenolic compounds) and cyclic phenolic resins (containing cyclic calixarene compounds). For instance, the resin can contain about 0-50% linear phenolic compounds and about 50-100% cyclic calixarene compounds. Typically, the resulting resin contains about 40-50% linear phenolic compounds and about 50-60% cyclic calixarene compounds.

The paraffin-containing fluid can be any hydrocarbon fluids in the oilfield that contain paraffin or paraffin wax. The term “hydrocarbon fluid” as used herein encompasses an oil and gas. The paraffin-containing hydrocarbon fluids include, but are not limited to a crude oil, home heating oil, lubricating oil (such as an engine oil), and natural gas. The resin should be soluble, or at least partially soluble, in the paraffin-containing fluid.

The paraffin-containing fluid can contain various amounts of paraffin or paraffin wax. For instance, the paraffin-containing fluid may contain at least 0.05 wt % of paraffin or paraffin wax, at least 0.1 wt % of paraffin or paraffin wax, at least 0.5 wt % of paraffin or paraffin wax, at least 1 wt % of paraffin or paraffin wax, at least 2 wt % of paraffin or paraffin wax, at least 3 wt % of paraffin or paraffin wax, at least 4 wt % of paraffin or paraffin wax, at least 5 wt % of paraffin or paraffin wax, at least 10 wt % of paraffin or paraffin wax, and up to about 15 wt % of paraffin or paraffin wax.

The calixarene resins discussed herein are paraffin inhibitors that can disperse the paraffin in the fluid composition or inhibit the deposition of the paraffin crystals. By “paraffin inhibitor,” the term refers to the ability of the calixarene resins to modify the morphology and surface properties of paraffin crystals, thereby inhibiting paraffin crystal precipitation, deposition, and/or any other mechanisms, or to disperse the paraffin crystals in the fluid composition, working as a surfactant.

An effective paraffin-inhibiting amount or dosage of the calixarene resin in the fluid, e.g., the paraffin-containing fluid, refers to the amount or dosage of the calixarene resin added to the paraffin-containing fluid that can present at least some level of paraffin inhibition (i.e., decreasing the level of paraffin crystal precipitation, deposition; and/or other any other mechanisms), as compared to the paraffin-containing fluid that does not contain the calixarene resin or any other paraffin inhibitors. Typically, increasing the dosage of the calixarene resin can enhance the paraffin inhibition performance. However, the paraffin inhibition performance is not always improved with increased dosage; too high a dosage of the calixarene resin may decrease the paraffin inhibition performance. The amount of the resin can typically range from about 1 to about 10,000 parts per million (ppm) in the paraffin-containing fluid, from about 10 to about 5000 parts per million in the paraffin-containing fluid, from about 10 to about 1000 parts per million in the paraffin-containing fluid, from about 10 to about 500 parts per million in the paraffin-containing fluid, or from about 10 to about 100 parts per million in the paraffin-containing fluid. In practice, the measurement of the dosage rate may be in μL/L, which is commonly used as an approximation for ppm in the oilfield industry.

Evaluation of the paraffin inhibition performance can be based on various methods known by one skilled in the art. For example, the cold finger test (using a cold finger device) is typically used for such evaluations. A typical cold finger device contains a temperature-controlled metal probe that is inserted into samples of stirred paraffin-containing fluid for specified time duration, usually about 16 hours. The cold finger probe is set to a temperature below the Wax Appearance Temperature (WAT) of the paraffin-containing fluid. The “bulk” paraffin-containing fluid temperature is generally set at or slightly above the WAT of the paraffin-containing fluid and is controlled at the surface of the wall of the bottle containing the paraffin-containing fluid sample. With proper control of the bulk paraffin-containing fluid and cold finger temperatures, a driving force for the paraffin deposition—i.e., the temperature difference between the bulk paraffin-containing fluid and the cold finger probe—can be set such that the cold finger set-up can be used to simulate a section of flow line in a production system. The cold finger surface simulates a cold flowline surface and stirring simulates the flowline flow-field. The amount of paraffin deposition on the cold finger probes after testing can be examined to evaluate the differences in the paraffin-containing fluid that are treated with the calixarene resin versus those that are not treated with the calixarene resin (control). The percent inhibition of the paraffin wax deposition by the resin can be determined by comparing the weight of the deposit from the treated sample against the weight of the deposit from the control.

As shown in the examples below, the calixarene resin improves the dispersion and/or inhibits the paraffin deposition, as compared to a paraffin-containing fluid composition that does not contain the resin, by at least 5%, at least 10%, at least 15%, at least 20%, at least 25%, at least 30%, at least 35%, at least 40%, at least 45%, at least 50%, at least 60%, at least 70%, at least 80%, at least 90%, or at least 95%.

Another aspect of the invention relates to a method for dispersing paraffin crystals or inhibiting paraffin crystal deposition in a paraffin-containing fluid. The method comprises adding to a paraffin-containing fluid an effective amount of a resin comprising one or more calixarene compounds, wherein the resin is at least partially soluble in the paraffin-containing fluid. The resin disperses the paraffin in the paraffin-containing fluid and/or inhibits the deposition of the paraffin crystals.

The resin used in the method for dispersing paraffin crystals and/or inhibiting paraffin crystal deposition in a paraffin-containing fluid is the same calixarene resin described in the above embodiments. All the descriptions in the above embodiments relating to the calixarene resins and the process of preparing thereof are applicable in the method for dispersing paraffin crystals or inhibiting paraffin crystal deposition in a paraffin-containing fluid.

Moreover, all the above embodiments relating to the paraffin-containing fluid, the amounts of paraffin or paraffin wax contained in the paraffin-containing fluid, the amounts or dosages of the calixarene resin in the paraffin-containing fluid, the evaluating methods for the paraffin inhibition performance, and the paraffin inhibition abilities of the calixarene resins described in the embodiments relating to the paraffin-containing fluid composition are applicable in the method for dispersing paraffin crystals or inhibiting paraffin crystal deposition in a paraffin-containing fluid.

Another aspect of the invention relates to a method for treating a well or vessel surface to reduce the deposition of paraffin crystals on the well or vessel surface. The method comprises treating the well or vessel surface with a resin composition comprising an effective amount of a resin. The resin comprises one or more calixarene compounds. The treatment reduces the deposition of paraffin crystals on the well or vessel surface.

The resin used in the method for treating a well or vessel surface to reduce the deposition of paraffin crystals on the well or vessel surface is the same calixarene resin described in the above embodiments. All the descriptions in the above embodiments relating to the calixarene resin and the process of preparing thereof are applicable in the method for treating a well or vessel surface to reduce the deposition of paraffin crystals on the well surface.

The surface to be treated by the resin composition includes any surface that is in contact or has been in contact with a paraffin-containing petroleum fluid, and can be the surface of a well or any vessel that has the problem of paraffin wax deposition during oilfield operations. The surface to be treated can include wells (such as a gas well or oil well), pipelines, flowlines, tanks, tank cars, separation vessels, and other processing vessels in which paraffin wax deposition may occur. For instance, the surface to be treated can be the surfaces of artificial lift pump components, such as the components for rod pumps (also referred to as “sucker rod pumps”).

The resin can be premixed with a fluid to form a fluid resin composition to treat the well or vessel surface. The calixarene resin should be soluble or at least partially soluble in the fluid to be premixed therewith. The fluid can be any hydrocarbon fluid in the oilfield including, but not limited to, a crude oil, home heating oil, lubricating oil (such as an engine oil), and natural gas. These oilfield hydrocarbon fluids typically contain paraffin or paraffin wax.

Alternatively, the fluid can be a hydrocarbon solvent that may or may not contain paraffin or paraffin wax, acting as a fluid carrier for the resin composition to be contacted with the well or vessel surface to treat the surface or the paraffin-containing fluid itself. Suitable hydrocarbon solvents include, but are not limited to, alkanes (such as C₄-C₂₄ n-alkanes; e.g., C₅-C₁₆ n-alkanes), cycloalkanes (such as C₃-C₂₄ cycloalkanes; e.g., C₅-C₁₆ cycloalkanes), aromatic hydrocarbons (such as alkylbenzenes or naphthalenes; e.g., a C₇-C₁₂ aromatic hydrocarbon solvent), and combinations thereof. Exemplary hydrocarbon solvents are kerosene, diesel, heptane, benzene, toluene, xylene, Solvesso™ aromatic fluids (C₉-C₁₂ aromatic hydrocarbon solvents), and combinations thereof.

The fluid can also be a pre-mixture of any hydrocarbon fluid in the oilfield discussed above and any hydrocarbon solvent discussed above. For instance, the fluid can be a produced crude oil or lubricating oil, premixed with any hydrocarbon solvent discussed above.

Alternatively, the resin compositions can be contacted with the well or vessel surface directly (e.g., by injecting the resin composition into a well or vessel) at any point where it would be desirable to inhibit the deposition of paraffin or paraffin wax. For example, the resin compositions can be injected downhole at or near the producing section of the well. Alternatively, the resin compositions can be injected near the top of the well or even into separation devices used to separate hydrocarbons from aqueous components of a formation fluid, or into other process streams containing petroleum fluids. During the injection, the resin compositions can mix with any fluid already contained in the well or vessel, e.g., a crude oil, a formation fluid, etc.

The application of the resin composition to treat the well or vessel surface can be a preventive treatment (i.e., to prevent the deposition of paraffin crystals on the well or vessel surface) or a remedial treatment (i.e., to treat a surface that already shows signs of paraffin deposition).

Moreover, all the above embodiments relating to the fluid, the hydrocarbon fluid, the paraffin-containing fluid, the amounts of paraffin or paraffin wax contained in the paraffin-containing fluid, the amounts or dosages of the calixarene resin in the fluid such as the paraffin-containing fluid, the evaluating methods for the paraffin inhibition performance, and the paraffin inhibition abilities of the calixarene resins described in the embodiments relating to the paraffin-containing fluid composition are applicable in the method for treating a well or vessel surface to reduce the deposition of paraffin crystals on the well or vessel surface.

Additional aspects, advantages and features of the invention are set forth in this specification, and in part will become apparent to those skilled in the art on examination of the following, or may be learned by practice of the invention. The inventions disclosed in this application are not limited to any particular set of or combination of aspects, advantages and features. It is contemplated that various combinations of the stated aspects, advantages and features make up the inventions disclosed in this application.

### EXAMPLES

The following examples are given as particular embodiments of the invention and to demonstrate the practice and advantages thereof. It is to be understood that the examples are given by way of illustration and are not intended to limit the specification or the claims that follow in any manner.

### Example 1: Synthesis of a Mixture of Calixarene/Linear Alkylphenolic Resins Based on Para-Tert-Butylphenol and Para-Nonylphenol

A reaction vessel was charged with para-butylphenol and para-nonylphenol, Solvesso™ 150ND solvent (an aromatic solvent commercially available from ExxonMobil Chemicals), and sodium hydroxide. Formalin was added to the reaction mixture over a period of 0.5 to 1.5 hours. The reaction mixture was then heated to reflux and the reaction was completed within 3-4 hours, Solvesso™ 150 solvent was added to the reaction mixture to adjust the percentage of the resulting resins to 53-55 wt %. During the reaction, the product started to precipitate out of the resin solution. The final yield was 97%, and the appearance of the product was a suspension of partially insoluble material.

Samples of the final product were left under room temperature, and placed in the freezer at −25° C. for 24 hours. The insoluble solid precipitate was isolated and weighted.

### Example 2: Paraffin Deposition Inhibition Using the Calixarene Resins

A simulated waxy crude oil was prepared by adding 5.7 wt % of paraffin waxes (Sasol wax, Sandton, South Africa) into a mixture of kerosene, heptane and xylenes. This simulated waxy crude oil formulation is shown in Table 1 below.

TABLE 1
Simulated Crude Oil Formulation

| | |
|---|---|
| Kerosene | 66.0% |
| Heptane | 18.9% |
| Xylene | 9.4% |
| Sasolwax 4610 | 2.8% |
| Sasolwax 4110 | 1.9% |
| Sasolwax C80M | 0.9% |
| Sasolwax H1 | 0.1% |

The simulated waxy crude was conditioned in an oven at a temperature of 100° C. for about 1-2 hours, and then partitioned into 6 cold finger test jars, each being equipped with a magnetic stir rod. The jars were then treated with a calixarene resin, prepared according to Example 1, at a dosage rate of 1000 ppm, 500 ppm, 250 ppm, and 100 ppm (i.e., μL/L, which is commonly used as an approximation for ppm in the oilfield industry) of a 55 wt % active resin product solution in Solvesso 150 solvent, respectively. That is to say, for instance, 100 ppm dosage rate refers to adding 100 μL resin solution (55 wt % active product in Solvesso 150 solvent) per 1 L of Simulated Crude Oil Formulation (as listed in Table 1). Once treated, the jars were secured to the cold finger probes of the Multi-Place Cold Finger Model 0.62 (F5 Technologie GmbH, Wunstorf, Germany) and placed into a hot water bath at a temperature of 38° C. Magnetic stirring at 350 rpm was turned on and the cold finger probes were activated to cool to 29° C. The samples were maintained in this way for about 16 hours. The jars were then detached from the cold finger probes and the waxy solution was drained off the probes.

The deposited wax on the cold finger probes was assessed gravimetrically by scraping the deposit off of the probes and onto weighing paper. Percent inhibition of the paraffin wax deposition by the resin was determined by comparing the mass of the deposit from the control (Mass of Deposit_{control}, i.e., the sample that was not treated with the resin) and the mass of the deposit from the treated sample (Mass of Depositₜᵣₑₐₜₘₑₙₜ, i.e., the sample that was treated with the resin), using the following formula:

$$\% Inhibition = ( \frac{Mass of {Deposit}_{control} - Mass of {Deposit}_{treatment}}{Mass of {Deposit}_{control}} ) \times 100$$

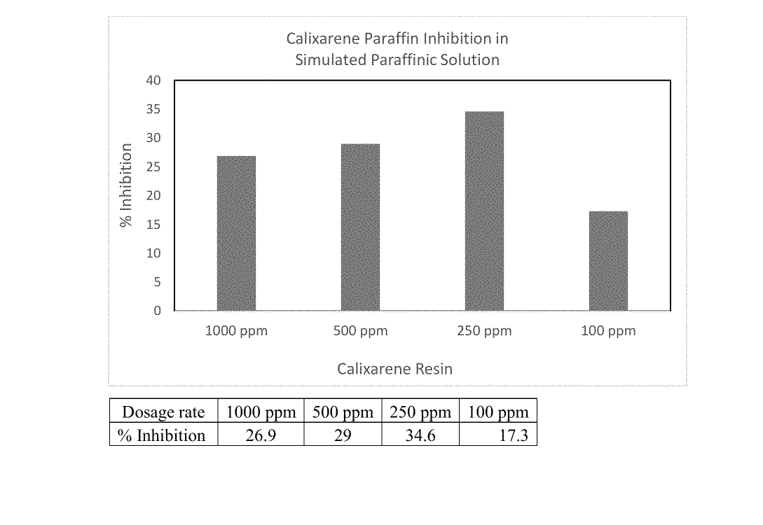

FIG. 1 shows the paraffin inhibition performance (% inhibition as described above) of the calixarene resin in the simulated waxy crude at different dosage levels (1000 ppm, 500 ppm, 250 ppm, and 100 ppm, respectively). The data show that the calixarene resin provided paraffin inhibition at each dosage level compared to the control, i.e., the sample that was not treated with the resin, which has 0% paraffin inhibition, as the % inhibition was calculated relative to the control.

In a cold finger test in which the paraffin wax deposition may occur for 16 hours, the calixarene resin had shown about 35% inhibition of paraffin wax deposition at the dosage level of 250 ppm.

Although preferred embodiments have been depicted and described in detail herein, it will be apparent to those skilled in the art that various modifications, additions, substitutions, and the like can be made without departing from the spirit of the invention and these are therefore considered to be within the scope of the invention as defined in the claims which follow.

We claim:

1. A method for dispersing paraffin crystals or inhibiting paraffin crystal deposition in a paraffin-containing fluid, comprising:
adding to a paraffin-containing fluid an effective amount of a resin comprising one or more calixarene compounds, wherein the resin is at least partially soluble in the paraffin-containing fluid, and wherein the resin disperses the paraffin in the paraffin-containing fluid and/or inhibits the deposition of the paraffin crystals.

2. The method of claim 1, wherein the resin is a phenolic aldehyde calixarene resin prepared in the presence of a base catalyst.

3. The method of claim 1, wherein the phenolic units in the resin are the same or different phenolic compounds, each compound independently selected from the group consisting of phenol, resorcinol, and pyrogallol, wherein the benzene rings of the phenolic units are independently substituted with H, C₁ to C₃₀ alkyl, phenyl, or arylalkyl.

4. The method of claim 3, wherein the phenolic units in the resin are the same or different phenols, each independently substituted with C₄ to C₁₂ alkyl.

5. The method of claim 1, wherein the total number of units in the calixarene compounds is from 4-8.

6. The method of claim 1, wherein the paraffin-containing fluid is a hydrocarbon fluid selected from the group consisting of a crude oil, home heating oil, lubricating oil, and natural gas.

7. The method of claim 1, wherein the amount of the resin is from about 10 to about 100 parts per million in the paraffin-containing fluid.

8. A method for treating a well or vessel surface to reduce the deposition of paraffin crystals on the well or vessel surface, comprising:
treating the well or vessel surface with a resin composition comprising an effective amount of a resin comprising one or more calixarene compounds, wherein the treatment reduces the deposition of paraffin crystals on the well or vessel surface.

9. The method of claim 8, wherein the resin is a phenolic aldehyde calixarene resin prepared in the presence of a base catalyst.

10. The method of claim 8, wherein the phenolic units in the resin are the same or different phenolic compounds, each compound independently selected from the group consisting of phenol, resorcinol, and pyrogallol, wherein the benzene rings of the phenolic units are independently substituted with H, C₁ to C₃₀ alkyl, phenyl, or arylalkyl.

11. The method of claim 10, wherein the phenolic units in the resin are the same or different phenols, each independently substituted with C₄ to C₁₂ alkyl.

12. The method of claim 8, wherein the well or vessel surface is the surface of a gas well, oil well, pipeline, flowline, tank, tank car, or processing vessel.

13. The method of claim 8, wherein the resin composition further comprises a hydrocarbon fluid that the resin is at least partially soluble in, selected from the group consisting of a crude oil, home heating oil, lubricating oil, and natural gas.

14. The method of claim 13, wherein the hydrocarbon fluid comprises one or more hydrocarbon solvents selected from the group consisting of kerosene, diesel, heptane, benzene, toluene, xylene, C₉-C₁₂ aromatic hydrocarbon solvents, and combinations thereof.

15. The method of claim 13, wherein the amount of the resin is from about 10 to about 100 parts per million in the hydrocarbon fluid.

16. A paraffin-containing fluid composition comprising:
a) a paraffin-containing fluid; and
b) a resin comprising one or more calixarene compounds, wherein the resin is at least partially soluble in the paraffin-containing fluid, wherein the resin disperses the paraffin in the fluid composition and/or inhibits the deposition of the paraffin crystals.

17. The paraffin-containing fluid composition of claim 16, wherein the resin is a phenolic aldehyde calixarene resin prepared in the presence of a base catalyst.

18. The paraffin-containing fluid composition of claim 16, wherein the phenolic units in the resin are the same or different phenolic compounds, each independently selected from the group consisting of phenol, resorcinol, and pyrogallol, wherein the benzene rings of the phenolic units are independently substituted with H, C₁ to C₃₀ alkyl, phenyl, or arylalkyl.

19. The paraffin-containing fluid composition of claim 18, wherein the phenolic units in the resin are the same or different phenols, each independently substituted with C₄ to C₁₂ alkyl.

20. The paraffin-containing fluid composition of claim 16, wherein the total number of units in the calixarene compounds is from 4-8.

21. The paraffin-containing fluid composition of claim 16, wherein the paraffin-containing fluid is a hydrocarbon fluid selected from the group consisting of a crude oil, home heating oil, lubricating oil, and natural gas.

22. The paraffin-containing fluid composition of claim 16, wherein the amount of the resin is from about 10 to about 100 parts per million in the paraffin-containing fluid.

23. The paraffin-containing fluid composition of claim 22, wherein the resin improves the paraffin dispersion and/or inhibits the paraffin deposition by at least 20% compared to a paraffin-containing fluid composition that does not contain the resin.
